(19) United States
(12) Patent Application Publication
(10) Pub. No.: US 2008/0266497 A1
(43) Pub. Date: Oct. 30, 2008

(54) Liquid crystal display

(75) Inventor: Hung-Yu Chen, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 12/150,362

(22) Filed: Apr. 28, 2008

(30) Foreign Application Priority Data
Apr. 27, 2007 (CN) 200710074231.7

(51) Int. Cl. G02F 1/1335

(52) U.S. Cl. 349/106

(57) ABSTRACT

An exemplary liquid crystal display has a liquid crystal panel (2). The liquid crystal panel includes a first substrate (21); a second substrate (22); and a liquid crystal layer (23) disposed between the first and second substrates. The liquid crystal panel further includes a black matrix (210) formed at one side of the first substrate face to the liquid crystal layer; a color filter layer (211) including a plurality of color filter units disposed regularly and separately at the black matrix, and a conductive layer (212) covering the black matrix and the color filter layer, electrically coupled to the black matrix. The black matrix is electrically conductive.

### FIELD OF THE INVENTION

The present invention relates to a liquid crystal display having a black matrix electrically coupled to a conductive layer to form a common electrode.

### GENERAL BACKGROUND

Liquid crystal displays (LCDs) are widely used in various modern information products, such as notebooks, personal digital assistants, video cameras and the like. A typical LCD includes a liquid crystal panel. The liquid crystal panel is used to display images according to driving signals transmitted thereto.

Referring to FIG. 4, an equivalent circuit diagram of one pixel unit of a typical liquid crystal display is shown. The pixel unit 1 has a gate line Ga, a data line Da, a thin film transistor (TFT) T, a storage capacitor Cs, a pixel electrode Vpixel and a common electrode Vcom. The common electrode Vcom is equivalent to an inner resistor R and a voltage node V because its impedance characteristic. The TFT T has a gate electrode (not labeled), a source electrode (not labeled) and a drain electrode (not labeled), the gate electrode being connected to the gate line Ga, the source electrode being electrically coupled to the data line Da, and the drain electrode being electrically coupled to the pixel electrode Vpixel. The pixel electrode Vpixel, the common electrode Vcom and liquid crystal molecules (not shown) therebetween cooperatively form a liquid crystal capacitor Clc. The storage capacitor Cs and the liquid crystal capacitor Clc are connected in parallel in the pixel unit 1.

In operation, a common voltage signal is applied to the common electrode Vcom. A scanning signal is applied to the TFT T of the pixel unit 1 via the corresponding gate line Ga, such that the TFT T is switched on. A data voltage signal is applied to the pixel electrode Vpixel via the corresponding data line Da and the on-state TFT T. Thereby, the liquid crystal capacitor Clc and the storage capacitor Cs are charged simultaneously, and an electric field is generated between the pixel electrode Vpixel and the common electrode Vcom. The electric field causes the liquid crystal molecules of the liquid crystal layer (not shown) to twist to a corresponding angle, so as to enable the pixel unit 1 to display a particular color (red, green, or blue) having a corresponding gray level. The aggregation of colors displayed by all the pixel units 1 simultaneously constitutes an image viewed by a user of the liquid crystal display.

However, the common voltage provided to the liquid crystal capacitor Vlc is easy to be influenced by peripheral pixel units 1 and produces a voltage difference. In addition, the inner resistor R and the liquid crystal capacitor form a RC delay circuit, which produces a delay effect. Thus, the voltage difference of the common electrode Vcom is not easy to be removed because the delay effect thereof. Thus, the electrical field generated between the pixel electrode Vpixel and the common electrode Vcom is unstable. Therefore, luminance of the liquid crystal display at the corresponding region is influenced, which makes the luminance over the whole liquid crystal display non-uniform. This non-uniform display is named as crosstalk.

What is needed is a liquid crystal display that can overcome the above-described deficiencies.

### SUMMARY

An exemplary liquid crystal display has a liquid crystal panel. The liquid crystal panel includes a first substrate; a second substrate; and a liquid crystal layer disposed between the first and second substrates. The liquid crystal panel further includes a black matrix formed at one side of the first substrate face to the liquid crystal layer; a color filter layer including a plurality of color filter units disposed regularly and separately at the black matrix, and a conductive layer covering the black matrix and the color filter layer, electrically coupled to the black matrix. The black matrix is electrically conductive.

Other novel features and advantages will become more apparent from the following detailed description when taken in conjunction with the accompanying drawings.

### BRIEF DESCRIPTION OF THE DRAWINGS

FIG. 1 is a cross-sectional view of a liquid crystal panel of a liquid crystal display according to a first embodiment of the present invention, which has an upper substrate.

FIG. 2 is a bottom view of the upper substrate.

FIG. 3 is an equivalent circuit diagram of one pixel unit of the liquid crystal display of FIG. 1.

FIG. 4 is an equivalent circuit diagram of one pixel unit of a conventional liquid crystal display.

### DETAILED DESCRIPTION OF PREFERRED EMBODIMENTS

Reference will now be made to the drawings to describe preferred and exemplary embodiments of the present invention in detail.

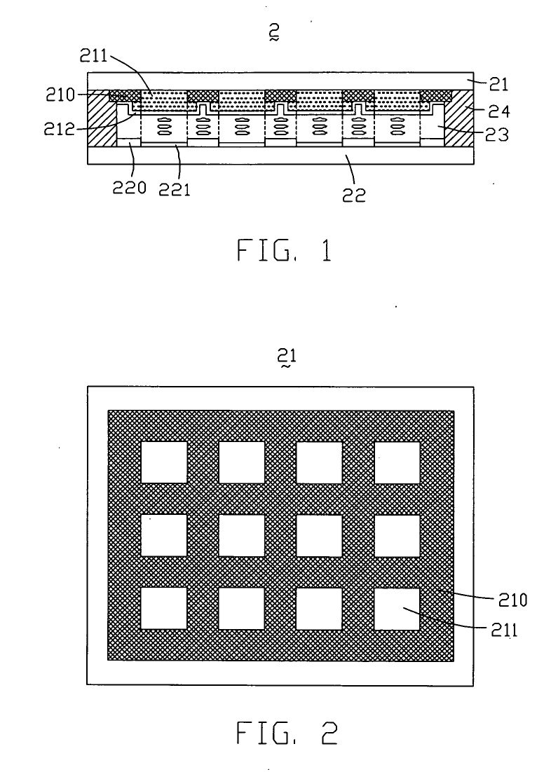

FIG. 1 is a cross-sectional view of a liquid crystal panel of a liquid crystal display according to a first embodiment of the present invention. The liquid crystal panel 2 has a upper substrate 21, a lower substrate 22 opposite to the upper substrate 21, a liquid crystal layer 23 sandwiched between the upper and the lower substrates 21, 22. A sealant 24 is disposed between the upper substrate 21 and the lower substrate 22, and cooperates with the upper substrate 21 and the lower substrate 22 to form a closed accommodating space (not labeled) therebetween. The liquid crystal layer 23 is received in the accommodating space.

Referring to FIG. 2, a bottom view of the upper substrate 21 is shown. A black matrix 210, a color filter (CF) layer 211 and a conductive layer 212 are provided on one side of the upper substrate 21, adjacent to the liquid crystal layer 23. The black matrix 210 is disposed on the upper substrate 21, which defines a plurality of grids distributed in matrix. The peripheral region of the black matrix 210 abuts against a part of the sealant 24. The black matrix 210 is made from an insulating material, such as black resin, black latex or their admixture, doped with a conductive material, such as conductive fiber, copper particles, or aluminium particles. That is the black matrix 210 has an electrical conductive characteristics. The CF layer 211 includes a plurality of color filter units R, G, B disposed regularly and separately at the grids of the black matrix 210. The conductive layer 212 covers the black matrix 210 and the CF layer 211, which is made from a transparent material, such as indium tin oxide (ITO) or indium zinc oxide (IZO). The conductive layer 212 electrically touches the black matrix 210, which cooperates to form a common electrode.

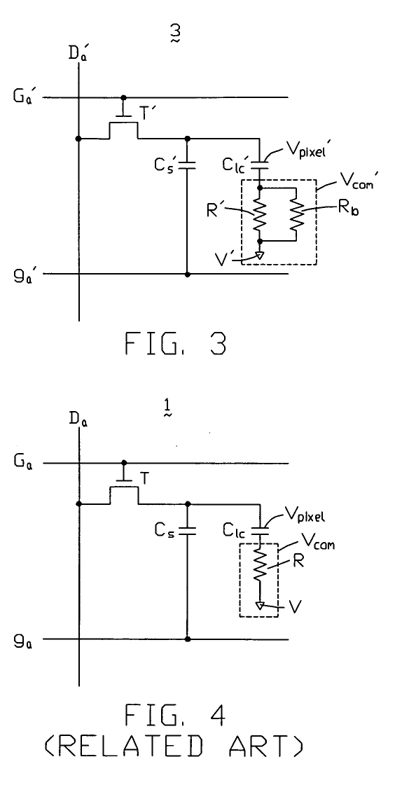

The lower substrate 22 has a plurality of gate lines Ga′ (as shown in FIG. 3), a plurality of data lines Da′, a plurality of thin film transistors (TFTs) 220 and a plurality of pixel electrodes 221. The plurality of gate lines and the plurality of data lines provide voltage signal to the plurality of pixel electrodes 221 via the plurality of TFTs 220. In assemble, the data lines Ga′, the gate lines Da′ and the TFTs 220 corresponds to the black matrix 210.

Referring to FIG. 3, an equivalent circuit diagram of one pixel unit of the liquid crystal display 2 is shown. The pixel unit 3 has the gate line Ga′, the data line Da′, the thin film transistor (TFT) T′, a storage capacitor Cs′, a pixel electrode Vpixel′, a liquid crystal capacitor Clc′, and a common electrode Vcom′. The common electrode Vcom′ is equivalent to an inner resistor R′ and a voltage node V′ because its impedance characteristic. The black matrix 210 is equivalent to a black matrix resistor Rb, parallel connect with the inner resistor R′ to form a parallel resistance. The parallel resistance electrically coupled between the voltage node V′ and the liquid crystal capacitor Clc′. The TFT T′ has a gate electrode (not labeled), a source electrode (not labeled) and a drain electrode (not labeled), the gate electrode being connected to the gate line Ga′, the source electrode being electrically coupled to the data line Da′, and the drain electrode being electrically coupled to the pixel electrode Vpixel′. The pixel electrode Vpixel′, the common electrode Vcom′ and liquid crystal molecules (not shown) therebetween cooperatively form the liquid crystal capacitor Clc′. The storage capacitor Cs′ is used to keep the voltage between the pixel electrode Vpixel′ and the common electrode Vcom′ invariable until next signal is applied.

In operation, a common voltage signal is applied to the common electrode Vcom′, which is applied to the liquid crystal capacitor Clc′ via the parallel resistance. A scanning signal is applied to the TFT T′ of the pixel unit 3 via the corresponding gate line Ga′, such that the TFT T′ is switched on. A data voltage signal is applied to the pixel electrode Vpixel′ via the corresponding data line Da′ and the on-state TFT T′. Thereby, the liquid crystal capacitor Clc′ and the storage capacitor Cs′ are charged simultaneously, and an electric field is generated between the pixel electrode Vpixel′ and the common electrode Vcom′. The electric field causes the liquid crystal molecules of the liquid crystal layer 23 to twist to a corresponding angle, so as to enable the pixel unit 3 to display a particular color (red, green, or blue) having a corresponding gray level. The aggregation of colors displayed by all the pixel units 3 simultaneously constitutes an image viewed by a user of the liquid crystal display. Although the common voltage applied to the liquid crystal capacitor Clc′ is easy to be influenced by other peripheral pixel units 3 to produce a common voltage difference, the common voltage difference can be rapidly eliminated because the parallel resistance has a lower resistance, comparing to the conventional pixel unit 1, and a smaller delay effect formed by the parallel resistance and the liquid crystal capacitor Clc′.

Thus, the liquid crystal panel 2 utilizes a common electrode defined by the conductive black matrix 210 electrically coupled to the conductive layer 212 to realize a high stability, which decreases the cross talk among the adjacent pixel units 3. In addition, the doped material in the black matrix 210 has a lower cost comparing to that of the conductive layer 212. Thus, the liquid crystal panel 2 has a lower cost.

It is to be further understood that even though numerous characteristics and advantages of preferred and exemplary embodiments have been set out in the foregoing description, together with details of structures and functions associated with the embodiments, the disclosure is illustrative only, and changes may be made in detail (including in matters of arrangement of parts) within the principles of the invention to the full extent indicated by the broad general meaning of the terms in which the appended claims are expressed.

What is claimed is:

1. A liquid crystal display, comprising:
a liquid crystal panel, which comprises:
a first substrate;
a second substrate; and
a liquid crystal layer disposed between the first and second substrates;
a black matrix formed at one side of the first substrate face to the liquid crystal layer, which is electrically conductive;
a color filter layer comprising a plurality of color filter units disposed regularly and separately at the black matrix and
a conductive layer covering the black matrix and the color filter layer, electrically coupled to the black matrix.

2. The liquid crystal display as claimed in claim 1, wherein the black matrix is made from an insulative material doped with an electrically conductive material, having electrically conductive characteristics.

3. The liquid crystal display as claimed in claim 1, wherein the conductive layer and the black matrix form a parallel resistance.

4. The liquid crystal display as claimed in claim 1, wherein the insulative material is resin, latex or their admixture.

5. The liquid crystal display as claimed in claim 1, wherein the conductive material is conductive fiber, or metal particles.

6. The liquid crystal display as claimed in claim 5, wherein the metal particles is copper particles, or aluminium particles.

7. The liquid crystal display as claimed in claim 1, wherein the conductive layer is a transparent conductive film.

8. The liquid crystal display as claimed in claim 7, wherein the conductive layer is made from indium tin oxide (ITO) and indium zinc oxide (IZO).

9. The liquid crystal display as claimed in claim 1, wherein the black matrix and the conductive layer define a common electrode.

10. The liquid crystal display as claimed in claim 1, further comprising a plurality of gate lines, a plurality of data lines, a plurality of thin film transistors and a plurality of pixel electrodes, which are formed at one side of the second substrate facing to the liquid crystal layer.

11. The liquid crystal display as claimed in claim 10, wherein the black matrix corresponds to the data lines, the gate lines and the TFTs.
